(19) United States
(12) Patent Application Publication
(10) Pub. No.: US 2025/0103790 A1
(43) Pub. Date: Mar. 27, 2025

(54) CONDITIONAL FORMATTING GUIDED BY PREDICTIVE EYE TRACKING

(71) Applicant: INTERNATIONAL BUSINESS MACHINES CORPORATION, ARMONK, NY (US)

(72) Inventors: Hamid Majdabadi, Ottowa (CA); Su Liu, Austin, TX (US); Neil Delima, Scarborough (CA); Jeffrey Alan Schmidt, Rochester, MN (US)

(21) Appl. No.: 18/472,330

(22) Filed: Sep. 22, 2023

(51) Int. Cl. G06F 40/103; G06F 3/01

(52) U.S. Cl. CPC G06F 40/103; G06F 3/013

(57) ABSTRACT

A system may receive information about a user, track a gaze of the user on a user interface, generate a real-time gaze heat map for the user, feed information about the user and the real-time gaze heat map into a machine learning model, determine, using the machine learning model based on the information about the user and the real-time gaze heat map, conditional formatting rules for data displayed on the user interface, and format, based on the conditional formatting rules, the data displayed on the user interface.

### BACKGROUND

Aspects of the present disclosure relate to detecting user requirements for conditional formatting, and more particular aspects relate to conditional formatting guided by predictive eye tracking.

Conditional formatting is a feature in business analytics tools that allows users to visualize data in a business intelligence (BI) dashboard or spreadsheet by highlighting cells with certain colors based on specific conditions. While this feature is useful, it is currently a manual process that requires users to create rules with custom formulas.

Adding conditional styles to a report can help better spot unusual or extraordinary results. If a given condition is true, a conditional style, such as cell shading or font color, is applied to objects.

### BRIEF SUMMARY

The present disclosure provides a method, computer program product, and system of conditional formatting guided by predictive eye tracking. In some embodiments, the method includes receiving information about a user, tracking a gaze of the user on a user interface, generating a real-time gaze heat map for the user, feeding information about the user and the real-time gaze heat map into a machine learning model, determining, using the machine learning model based on the information about the user and the real-time gaze heat map, conditional formatting rules for data displayed on the user interface, and formatting, based on the conditional formatting rules, the data displayed on the user interface.

Some embodiments of the present disclosure can also be illustrated by a computer program product comprising a computer readable storage medium having program instructions embodied therewith, the program instructions executable by a processor to cause the processors to perform a method, the method comprising receiving information about a user, tracking a gaze of the user on a user interface, generating a real-time gaze heat map for the user, feeding information about the user and the real-time gaze heat map into a machine learning model, determining, using the machine learning model based on the information about the user and the real-time gaze heat map, conditional formatting rules for data displayed on the user interface, and formatting, based on the conditional formatting rules, the data displayed on the user interface.

Some embodiments of the present disclosure can also be illustrated by a system comprising a processor and a memory in communication with the processor, the memory containing program instructions that, when executed by the processor, are configured to cause the processor to perform a method, the method comprising receiving information about a user, tracking a gaze of the user on a user interface, generating a real-time gaze heat map for the user, feeding information about the user and the real-time gaze heat map into a machine learning model, determining, using the machine learning model based on the information about the user and the real-time gaze heat map, conditional formatting rules for data displayed on the user interface, and formatting, based on the conditional formatting rules, the data displayed on the user interface.

Some embodiments of the present disclosure can also be illustrated by a system comprising a processor and a memory in communication with the processor, the memory containing program instructions that, when executed by the processor, are configured to cause the processor to perform a method, the method comprising receiving historical formatting preferences of a user, tracking a, eye focus point of the user on a user interface, generating a real-time gaze heat map for the user, feeding the historical formatting preferences and the real-time gaze heat map into a machine learning model, determining, using the machine learning model based on the historical formatting preferences and the real-time gaze heat map, conditional formatting rules for data displayed on the user interface, and formatting, based on the conditional formatting rules, the data displayed on the user interface.

In some embodiments, the method includes receiving historical formatting preferences of a user, tracking an eye focus point of the user on a user interface, generating a real-time gaze heat map for the user, feeding the historical formatting preferences and the real-time gaze heat map into a machine learning model, determining, using the machine learning model based on the historical formatting preferences and the real-time gaze heat map, conditional formatting rules for data displayed on the user interface, and formatting, based on the conditional formatting rules, the data displayed on the user interface.

### BRIEF DESCRIPTION OF THE DRAWINGS

FIG. 1 is a block diagram that illustrates an example computing environment, according to various embodiments of the present invention.

FIG. 2A is a display screen shot that illustrates an example system tracking a gaze of a user, according to various embodiments of the present invention.

FIG. 2B is a display screen shot that illustrates an example user interface before and after conditional formatting, according to various embodiments of the present invention.

FIG. 3 is a flowchart that illustrates an example method of conditional formatting guided by predictive eye tracking, according to various embodiments of the presentinvention.

FIG. 4 is a block diagram that depicts an example system for conditional formatting guided by predictive eye tracking, according to various embodiments of the presentinvention.

### DETAILED DESCRIPTION

Aspects of the present disclosure relate to conditional formatting guided by predictive eye tracking. While the present disclosure is not necessarily limited to such applications, various aspects of the disclosure may be appreciated through a discussion of various examples using this context.

AI platforms and machine learning models may be trained using neural networks may be trained to recognize patterns in input data by a repeated process of propagating training data through the network, identifying output errors, and altering the network to address the output error. Training data that has been reviewed by human annotators is typically used to train neural networks. Training data is propagated through the neural network, which recognizes patterns in the training data. Those patterns may be compared to patterns identified in the training data by the human annotators in order to assess the accuracy of the neural network. Mismatches between the patterns identified by a neural network and the patterns identified by human annotators may trigger a review of the neural network architecture to determine the particular neurons in the network that contributed to the mismatch. Those particular neurons may then be updated (e.g., by updating the weights applied to the function at those neurons) in an attempt to reduce the particular neurons' contributions to the mismatch. This process is repeated until the number of neurons contributing to the pattern mismatch is slowly reduced, and eventually the output of the neural network changes as a result. If that new output matches the expected output based on the review by the human annotators, the neural network is said to have been trained on thatdata.

Once a neural network has been sufficiently trained on training data sets for a particular subject matter, it may be used to detect patterns in analogous sets of live data (i.e., non-training data that have not been previously reviewed by human annotators, but that are related to the same subject matter as the training data). The neural network's pattern recognition capabilities can then be used for a variety of applications. For example, a neural network that is trained on a particular subject matter may be configured to review live data for that subject matter and predict the probability that a potential future event associated with that subject matter will occur.

However, accurate event prediction for some subject matters relies on processing live data sets that contain large amounts of data that are not structured in a way that allows computers to quickly process the data and derive a target prediction (i.e., a prediction for which a probability is sought) based on the data. This “unstructured data” may include, for example, various natural-language sources that discuss or somehow relate to the target prediction (such conditional formatting on spreadsheets desired by a user), uncategorized statistics that may relate to the target prediction, and other predictions that relate to the same subject matter as the target prediction. Further, achieving accurate predictions for some subject matters is difficult due to the amount of sentiment context present in unstructured data that may be relevant to a prediction. For example, the relevance of many social-media and blog posts to a prediction may be based almost solely on the sentiment context expressed in the post. Unfortunately, computer-based event prediction systems such as neural networks are not currently capable of utilizing this sentiment context in target predictions due, in part, to a difficulty in differentiating sentiment-context data that is likely to be relevant to a target prediction from sentiment-context data that is likely to be irrelevant to a target prediction. Without the ability to identify relevant sentiment-context data, the incorporation of sentiment analysis into neural-network prediction analysis may lead to severe inaccuracies. Training neural networks to overcome these inaccuracies may be impractical, or impossible, in most instances.

The amount of unstructured data that may be necessary for accurate prediction analysis may be so large for many subject matters that human reviewers are incapable of analyzing a significant percentage of the data in a reasonable amount of time. Further, in many subject matters, large amounts of unstructured data is made available frequently (e.g., daily), and thus unstructured data may lose relevance quickly. For this reason, human reviewers are not an effective means by which relevant sentiment-context data may be identified for the purposes of prediction analysis. Therefore, an event-prediction solution that is capable of analyzing large amounts of structured data, selecting the sentiment context therein that is relevant to a target prediction, and incorporating that sentiment context into a prediction is required.

Some embodiments of the present disclosure may improve upon neural-network predictive modeling by incorporating multiple specialized neural networks into a larger neural network that, in aggregate, is capable of analyzing large amounts of structured data, unstructured data, and sentiment context. In some embodiments one component neural network may be trained to analyze sentiment of unstructured data that is related to the target prediction, whereas another component neural network may be designed to identify lists of words or figures that may relate to the target prediction. As used herein, the terms “word” and “words” in connection with, for example, a “word type,” a “word list,” a “word vector,” an “identified word” or others may refer to a singular word (e.g., “payroll”) or a phrase (e.g., “revenue differential”). For this reason, a “word” as used herein in connection with the examples of the previous paragraph may be interpreted as a “token.” In some embodiments, this list of relevant words (e.g., entities) may be cross-referenced with sentiment-context

data that is also derived from the unstructured data in order to identify the sentiment-context data that is relevant to the target prediction. In some embodiments, the multiple neural networks may operate simultaneously, whereas in other embodiments the output of one or more neural networks may be received as inputs to another neural network, and therefore some neural networks may operate as precursors to another. In some embodiments, multiple target predictions may be determined by the overall neural network and combined with structured data in order to predict the likelihood of a value at a range of confidence levels. In some embodiments these neural networks may be any type of neural network. For example, “neural network” may refer to a classifier-type neural network, which may predict the outcome of a variable that has two or more classes (e.g., pass/fail, positive/negative/neutral, or complementary probabilities (e.g., 60% pass, 40% fail)). “Neural network” may also refer to a regression-type neural network, which may have a single output in the form, for example, of a numerical value.

In some embodiments, for example, a neural network in accordance with the present disclosure may be configured to generate a prediction of the probability of a target event (i.e., the event for which a probability is sought in a target prediction) related to a particular subject matter. This configuration may comprise organizing the component neural networks to feed into one another and training the component neural networks to process data related to the subject matter. In embodiments in which the output of one neural network may be used as the input to a second neural network, the transfer of data from the output of one neural network to the input of another may occur automatically, without user intervention.

For example, in some embodiments a predictive neural network may be utilized to predict the numerical probability that a particular cell in a spreadsheet should be conditionally formatted based on historical decisions of a user. The predictive neural network may be composed of multiple component neural networks that are complementarily specialized. For example, a first component neural network may be specialized in analyzing unstructured data related a type of data (e.g., financial, quota, etc.) to identify a list of entities in the unstructured data and identify sentiment data for each of those entities.

However, the list of entities and corresponding sentiment data may also contain irrelevant entities (and thus sentiment data). For example, a gaze heatmap may be used to determine portions of a display that are and are not of interest to a user. Therefore, a second component neural network may be specialized to review structured and unstructured data and identify a list of cells that the user is interested in. This list of entities may then be cross-referenced with the entities identified by the first component neural network. The sentiment data of the entities identified as relevant by the second component neural network may then be selected.

In this example, the list of cells identified by the second component neural network may be vectorized by a third component neural network. As a result, each entity from the list of entities may be represented by a corresponding word vector, and each feature vector may be associated with corresponding sentiment data. These word vectors and associated sentiment data may be input into a fourth component neural network. This fourth component neural network may be specialized to process the word vectors and sentiment data and output a numerical probability that the particular cell in the spreadsheet should have a particular conditional formatting (e.g., green, shaded, highlighted, etc.).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it isstored.

Computing environment 100 contains an example of an environment for the execution of at least some of the computer code involved in performing the inventive methods, such as code 301 configured with code to execute method 300 (detailed below). In addition to code 301, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code 301, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

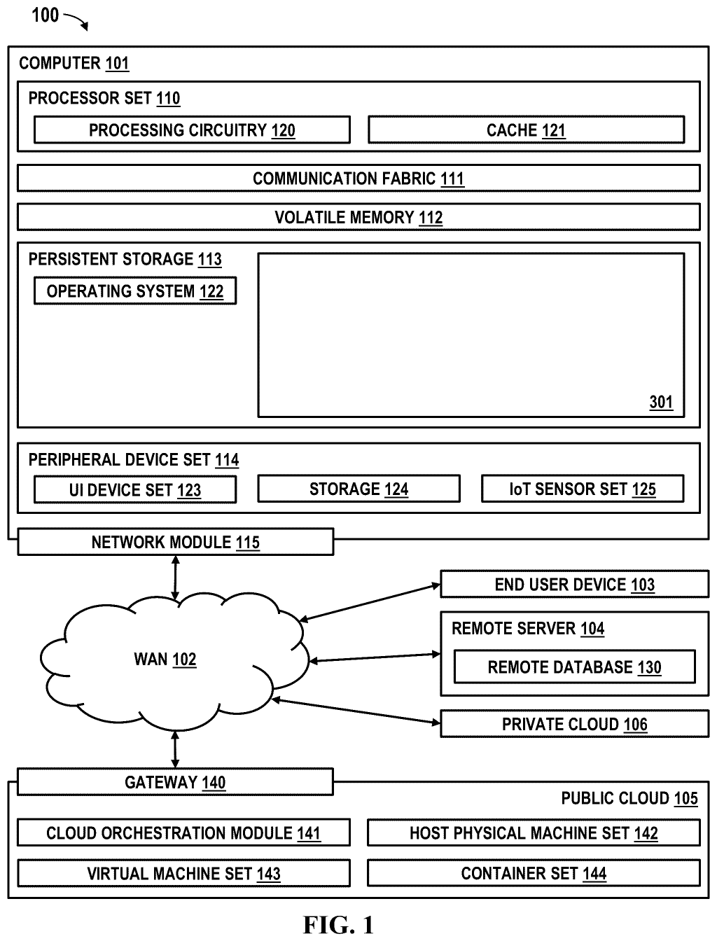

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code 301 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in code 301 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known ascontainerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The current process of conditional formatting in business analytics tools can be time-consuming and prone to errors. Users must manually create rules and formulas to highlight cells based on specific conditions and trends, which can be tedious and difficult tomanage.

There is a need for a more efficient and personalized method for applying real-time and on-demand conditional formatting to data sets based on the viewer's gaze and attention.

In some instances, a data modeler may generate reports with conditional formatting on a regular basis, such as daily, weekly or monthly, and need a way to ensure that the reports are accurate and up to date for decision making. Currently, there is no way for an artificial intelligence (AI) system to apply conditional formatting based on the eye focus of an individual taking into account the individual's role and formatting history.

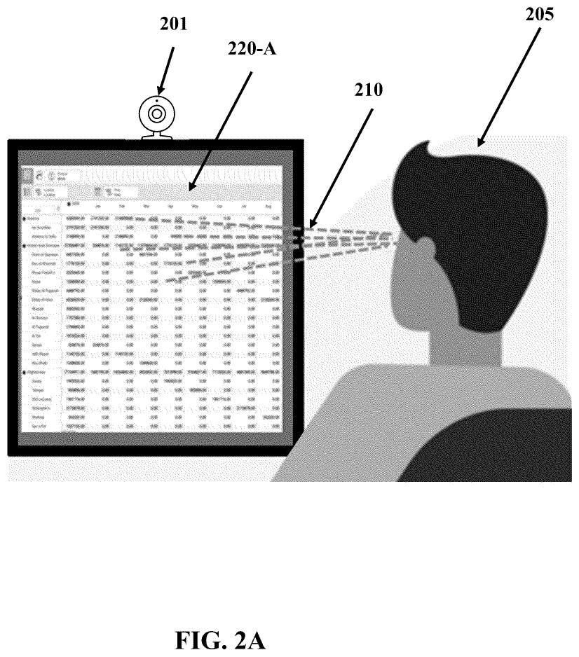

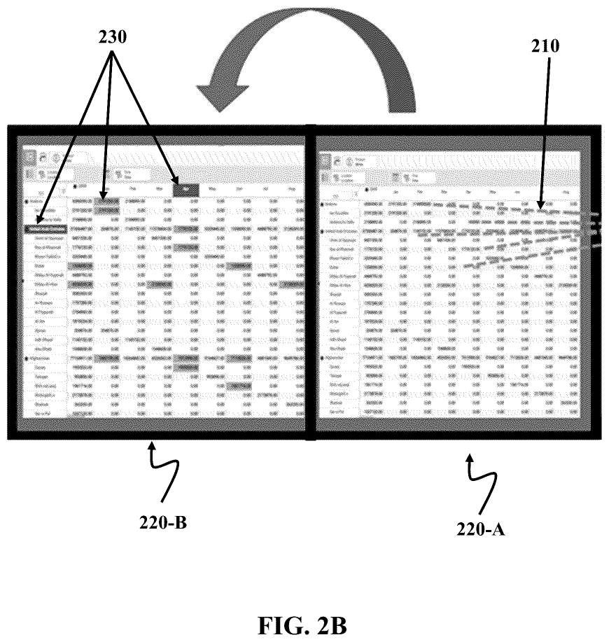

In some embodiments, the proposed method may use a user's gaze coordinate coupled with engagement attributes and set profile to determine conditional formatting that may be useful for a user. Referring to FIGS. 2A and 2B, IoT-based on-board or wearable eye-tracking IoT cameras (e.g., camera 201) for computers and other digital display devices may be used to track a gaze 210 of a user 205. FIG. 2A illustrates an example system tracking the gaze of a user. FIG. 2B illustrates an example user interface before and after conditionalformatting.

In some instances, eye-tracking devices are designed for integration into various applications computer programs or applications. In some embodiments, the eye-tracking devices are used to extrapolate one or more user eye focus points on a user interface and create a gaze heat map based on that information.

In some embodiments, the proposed system may use machine learning to analyze a gaze 210, along with other user data, to apply conditional formatting 230 to data displayed on a user interface 220. In some embodiments, user interface 220-A is prior to conditional formatting 230 and 220-B is after conditional formatting 230. In FIG. 2B, the arrows only point to example conditional formatting 230, as depicted, other formatting is present. In some embodiments, the conditional formatting may include a color change, a fill or texture change, highlighting, change in style, change in font, bolding, italicizing, or some other way of differentiating data on a user interface (e.g., a screen, tablet, 3D glasses, or other method of displaying data for a user). The proposed system provides technical innovations that may augment various applications, including accessibility features for people with disabilities, gaming, and virtual reality experiences.

In some embodiments, a system is proposed for intelligently incorporating IoT-powered predictive gaze-guided eye tracking in data analytic platforms fed by machine learning techniques coupled with report viewer intent, interest, and user role-based access control to dynamically implement real-time customized conditional formatting for data visualization. In some embodiments, based on a user gaze coordinate map focus for a particular dataset, an artificial intelligence (AI) platform uses a machine learning model to identify data trends, anomalies, and auto-activates a data conditional formatting in displayed data cells on a user interface in relation to a role of a user, a gaze heat map of the user, and pre-set triggering configurations.

In some embodiments, the proposed method involves the use of predictive eye-tracking and gaze guided technology to guide an AI platform in the generation of conditional formatting rules for data reporting and visualization. The use of AI for conditional formatting allows for the efficient and accurate customization of data visualization, enabling users to quickly identify trends, patterns, and anomalies (data trends and outliers deviance) in the presented data. In some instances, the IoT-driven system also allows for the easy implementation of multi-level conditional formatting rules based on user role and intent to further enhance clarity and usefulness of reports. In some embodiments, conditional formatting rules detail formatting of data by correlating gaze data with user role, intent, and engagement. The applied rules change how data is displayed on the user interface. In some embodiments, the AI system may be trained with historical information about the user's gaze patterns, formatting preferences, data interests, and engagement patterns.

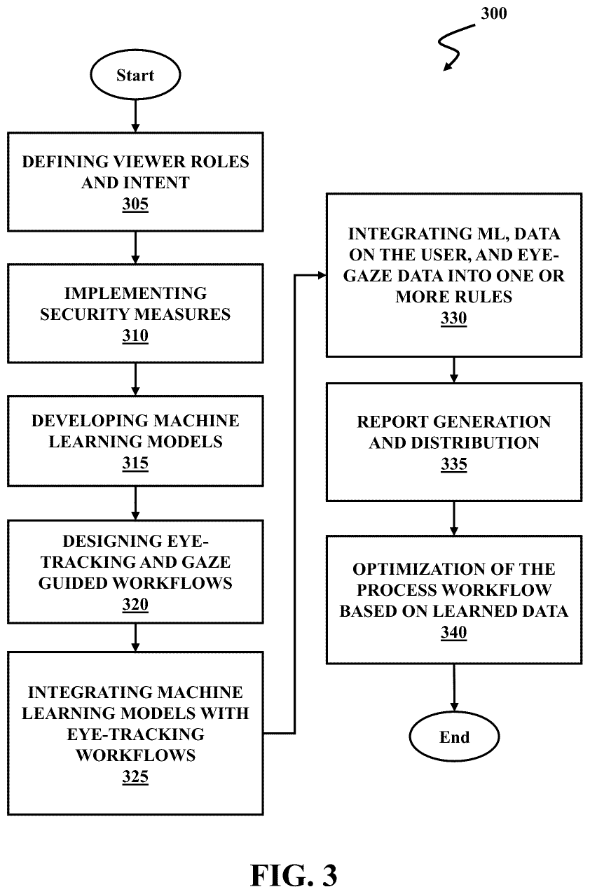

FIG. 3 depicts an example method 300 for conditional formatting guided by predictive eye tracking. Operations of method 300 may be enacted by code 301 in one or more computing environments such as the system described in FIG. 1 above.

Method 300 begins with operation 305 of defining viewer roles and intent. In some embodiments, a system may receive information identifying a role of the user (e.g., managers, analysts, executives). In some instances, the system may detect role-based access control based on a user platform sign-on that correlates to a security clearance (e.g., provided by a security group) that defines a user's access to data sets. In some embodiments, a user's access may be related to key performance indicators (KPIs). In some embodiments, the system may determine the specific interests and needs of each role. For example, interests for someone in accounting may have an interest in numbers related to employee payroll. In some embodiments, the system may establish KPIs relevant to each role. In some instances, the KPIs may include geo-location into a user role for area segmentation of the viewer.

In some embodiments, the system leverages the user initial platform authentication to identify user role and data access to secured assigned KPIs and measures in a database view. In some instances, a database view is a subset of a database and is based on a query that runs on one or more database tables. Database views may be saved in the database as named queries and can be used to save frequently used, complex queries.

Method 300 continues with operation 310 of implementing security measures to protect data and communication channels. In some embodiments, the system may encrypt data transmissions between the system and one or more external services. In some embodiments, the system may secure hardware and applications against unauthorized access. For example, the system may employ one or more security procedures or follow security policies designed to prevent unauthorized access to the system.

Method 300 continues with operation 315 of developing machine learning models for the AI platform. In some embodiments, the system may collect historical data on viewer interactions with visual data. In some embodiments, the system may train models to predict viewer intent and interest based on their role and past behavior. In some embodiments, the system may validate and refine models using cross-validation and performance metrics. In some instances, the system may incorporate user geography of interest based on a role of the user (e.g., area managers).

Method 300 continues with operation 320 of designing eye-tracking and gaze guided workflows by data modification and preprocessing. In some embodiments, the system may integrate IoT enabled on-board or add-on eye-tracking and gaze detection sensors into analytics and business intelligence (BI) platform. In some embodiments, the system may trigger eye-tracking sensors in real-time to track the gaze of a user at a particular displayed data point. For example, the user focusing on (e.g., gazing) a particular data cell in a spreadsheet may be interpreted by the system as user interest in that data cell. In some embodiments, the system may identify one or more data cells as a cell of interest for a user based on gaze information. In some instances, the gaze information may be in the form of a real-time gaze heat map.

In some instances, an eye gaze is visualization data about the most and least attention capturing sections and elements of the user interface. In some instances, data is gathered on how may times and how long a user looks at individual elements on a user interface, which is then plotted in the form of an eye tracking heatmap. In some instances, as described below, the system may use gaze information to identify elements of a user interface that the user is or is not engaged in (e.g., interested in) and which elements the user may think are redundant or confusing.

Method 300 continues with operation 325 of integrating machine learning models with eye-tracking workflows. In some embodiments, an AI platform ingests input data such as a gaze guided heat map (e.g., gaze heat map) for the user. In some embodiments, input data is correlated with user data and historical engagement data.

In some embodiments, the AI platform may identify user profile and ML data in a hybrid cloud and IoT data exchange. In some embodiments, the AI platform may detect and identify data sources and required data element specifications.

In some embodiments, the AI platform correlates real-time predictive eye-tracking and gaze-guided heat maps into data set views into business intelligence (BI) platform formatting schemes.

Method 300 continues with operation 330 of integrating ML, data on the user, and eye-gaze data into one or more rules predicting viewer intent, interest, and role. In some embodiments, the ML model outputs implement logic, based on estimating a user's intent and engagement, and integrates the implement logic into a profile for applying model predictions to determine appropriate conditional formatting rules. In some embodiments, real-time data formatting rule and update instructions are output to the software data specification. In some embodiments, a user's learned intent and interest is augmented using the user's data access, the user's assignment, and a user's personal profile. In some embodiments, ML input is continually fed by the new data from the eye-tracking sensors and updates to the user profile in the context of the conditional formatting feature of data analytic visualization.

In some embodiments, data visualization is auto formatted as a background specification and the background specification is triggered to update the data formatting. For example, a data file starts in some format (JavaScript Object Notation (JSON™), simple text, etc.), and this file is stored along with each report when saved. The formatting values are also stored in this file when a user saves the data. In the final stage of applying conditional formatting, the system may update the data specification file and update the view to display the updated formatting for the text.

In some embodiments, machine learning model outputs will be relevant formatting rules. In some embodiments, the ML model incorporates gaze heat map data into the rule creation process. In some embodiments, the AI platform may pass on the updated data specification containing a new formatting rule to a visualization processing module.

In some embodiments, the visualization processing module may apply conditional formatting rules to data visualizations. In some embodiments, the AI platform may customize formatting rules based on viewer role, predicted intent, and interest. In some embodiments, the AI platform may be configured to enhance data comprehension and decision-making for each user.

Method 300 continues with operation 335 of report generation and distribution. In some embodiments, the system may be configured to check the conditional formatting after a new format has been applied. For example, the system may check that the applied conditional formatting comports with the user's role and the user's data access level. In some embodiments, report generation and distribution refers to the final generation of the report and distribution of the report. For example, there may be other linked reports or copies to be updated based on the formatted file. In some embodiments, the distribution may also verify the generated outcome is appropriate for the user role and continues monitoring the user's gaze as one report may include more than one instance of a conditional formattingchange.

In some embodiments, the system may keep generating gaze heat maps and keep the AI platform active to monitor a cascading gaze of the user and update the conditionalformatting.

Method 300 continues with operation 340 of optimization of the process workflow based on learned data. In some embodiments, the system may monitor viewer engagement with the report and collection of the digital intent and interest to optimize the ML process. In some embodiments, the collected feedback from viewers and viewer usage data on the effectiveness of the customized conditional formatting may be used to increase the accuracy of the predictive ML model.

In some embodiments, the system may analyze viewer engagement data to identify areas for improvement. For example, the AI platform may update machine learning models and eye-tracking workflows based on feedback and new pattern recognition. In some embodiments, color-coding and parameters are exposed to the viewer through a visual indicator (i.e., tool tip/prompt based on data trends, outlier deviance, and anomalies).

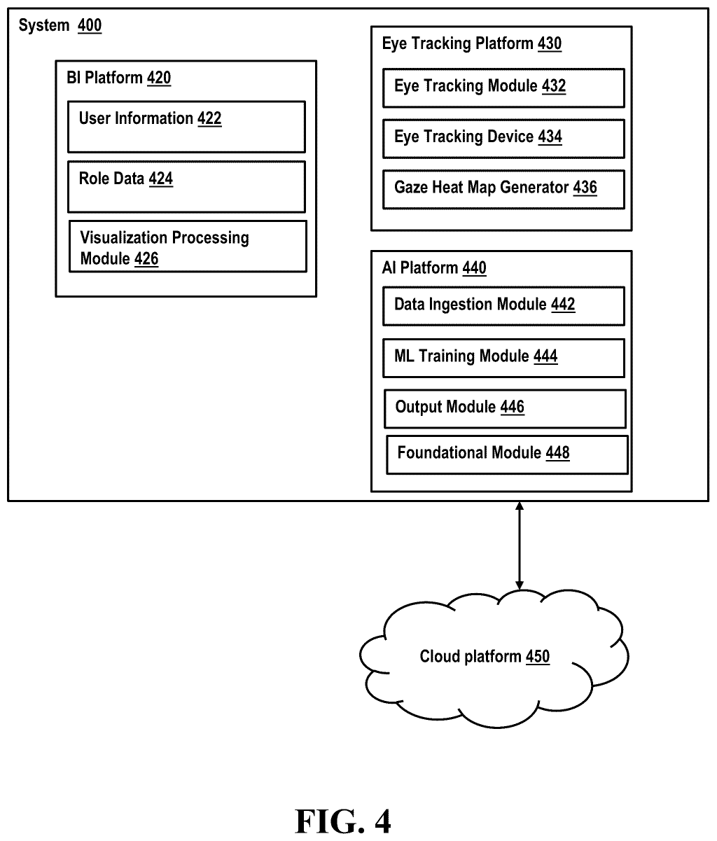

FIG. 4 depicts an example system 400 for conditional formatting guided by predictive eye tracking. In some embodiments, system 400 may include BI platform 420, eye tracking platform 430, and AI platform 440. In some embodiments, example system 400 may include a connection to a cloud platform 450 (e.g., wide area network 102). In some embodiments, predictive eye tracking and gaze-guided heat map is triggered by ML to interact with the data visualization specification to apply conditional formatting. In some instances, data visualization is the representation of data through use of graphics, such as charts, heat maps, plots, infographics, and even animations. In some embodiments, data visualization is dynamically updated in real-time with conditional formatting based on the user role, intent, interest, and user gaze guided engagement with the data cell.

In some embodiments, example system 400 may be installed on or include an on-board digital device, such as a tablet or smartphone, equipped with eye tracking device 434 (e.g., optical sensors) for eye tracking. In some embodiments, eye tracking module 432 is an eye tracking application that receives data from eye tracing device 434 and generates a gaze heat map with gaze heat map generator 436. In some embodiments, eye tracking device 434 includes on-board optical sensors that capture the user's eye movements and detect the gaze coordinate on the device screen. For example, a gaze heat map from eye tracking platform 430 may be used by AI platform 440 to determine that a user is focusing on a specific data cell within a real-time data visualization in a business analytic setting. In some embodiments, eye tracking platform 430 processes the captured eye tracking data locally on the device, identifying the gaze coordinate corresponding to the data (e.g., data cell) the user is focusing on.

In some embodiments, BI platform 420 may include user information 422, role data 424, and visualization processing module 426.

In some embodiments, eye tracking platform 430 may include eye tracking module 432, eye tracking device 434, and gaze heat map generator 436.

In some embodiments, AI platform 440 may include data ingestion module 442, ML training module 444, and output module 446. In some embodiments, AI platform 440 performs intelligent incorporation of IoT-Powered Predictive gaze-guided eye tracking in data analytic platforms fed by a machine learning algorithm, in ML training module 444, coupled with a report of a user's intent and interest, profile, and user role-based access control to dynamically implement real-time customized conditional formatting in datavisualization.

In some embodiments, the system may use a foundational model 448 to develop an AI system. In some instances, foundational model 448 can consolidate data from several sources so that one model may then be used for various activities. In some embodiments, various foundational model may be used as a starting point for the AI platform 440. For example, the AI platform may use a marketing foundation model for a marketing team example and then fine-tune, based on individual preferences, further training of the ML model to personalize preferences and interests for the user. For example, the foundation model can also be an industry related foundational model that may be adopted as a base model for a specific company and particular segments within the company. In some embodiments, using a base model may expedite the AI deployment. For instance, a foundational model is used to build a baseline ML model and then the model is further refined to fine-tune and customize the ML model for specific departments or tasks (one task would be when the system detects eye-gaze output data that is correlated with user preferences). In some embodiments, the foundational model augmented ML model is trained to personalize outputs based on user context, insight, and interest which may become part of the user historical interest. In some embodiments, aspects of the ML model may be used to augment the foundational model.

In some embodiments, eye tracking platform 430 establishes a connection to a cloud platform 450 or similar type of service. In some embodiments, eye tracking platform 430 securely transmits the gaze coordinate data (such as a gaze heat map), along with the relevant information about the focused data cell, to the cloud platform 450. In some embodiments, cloud platform 450 receives the gaze coordinate data and initiates further processing and analysis as described herein. In some embodiments, cloud platform 450 may use cloud-based services to process the gaze coordinate data and perform additional analysis, extracting insights or additional information related to the focused data cell in the data display. In some embodiments, the analyzed insights, predicted data conditional formatting rule, and additional details about the focused data cell are delivered back to system 400.

In some embodiments, system 400 may store access, analyze, and correlated filtered data from an external database through cloud platform 450 with AI platform 440 to augment a user profile with role-based access information. In some embodiments, cloud platform 450 may be used as a database point to import or export the user profile into other databases. In some embodiments, system 400 guided by the AI platform 440 may identify the relevant data sets based on the users' historical data engagement and role to identify the new database element and filtering required for each user based on log-in credentials into analytic or BI platforms.

In some embodiments, the described method may be initiated after one or more of the following prerequisites have been identified or reached a threshold level in a document: security group access level assignment, user platform sign-on credentials, historical data on viewer interactions with visual data, data sources and specifications, current base view dashboards, and pre-set configurations.

In some embodiments, the method may be directed to apply conditional formatting when one or more of the following prerequisites have been identified or reached a threshold level: automated report viewer intent and interest based on their role and past behavior, encrypted transmissions between a device and external services, secure applications and devices against unauthorized access, trained machine learning models, transformed and structured data, applied machine learning models to determine applicable conditional formatting rules, automated report generation and distribution, customized conditional formatting based on viewer role, predicted intent, and interest, and cascading conditional formatting applied in related reports across multiple data dimensions in a dashboard.

Artificial neural networks (ANNs) can be computing systems modeled after the biological neural networks found in animal brains. Such systems learn (i.e., progressively improve performance) to do tasks by considering examples, generally without task-specific programming. For example, in image recognition, ANNs might learn to identify images that contain cats by analyzing example images that have been manually labeled as “cat” or “no cat” and using the analytic results to identify cats in other images.

In some embodiments of the present disclosure, neural networks may be used to recognize new sources of knowledge. Neural networks may be trained to recognize patterns in input data by a repeated process of propagating training data through the network, identifying output errors, and altering the network to address the output error. Training data may be propagated through the neural network, which recognizes patterns in the training data. Those patterns may be compared to patterns identified in the training data by the human annotators in order to assess the accuracy of the neural network. In some embodiments, mismatches between the patterns identified by a neural network and the patterns identified by human annotators may trigger a review of the neural network architecture to determine the particular neurons in the network that contribute to the mismatch. Those particular neurons may then be updated (e.g., by updating the weights applied to the function at those neurons) in an attempt to reduce the particular neurons' contributions to the mismatch. In some embodiments, random changes are made to update the neurons. This process may be repeated until the number of neurons contributing to the pattern mismatch is slowly reduced, and eventually, the output of the neural network changes as a result. If that new output matches the expected output based on the review by the human annotators, the neural network is said to have been trained on that data.

In some embodiments, once a neural network has been sufficiently trained on training data sets for a particular subject matter, it may be used to detect patterns in analogous sets of live data (i.e., non-training data that has not been previously reviewed by human annotators, but that are related to the same subject matter as the training data). The neural network's pattern recognition capabilities can then be used for a variety of applications. For example, a neural network that is trained on a particular subject matter may be configured to review live data for that subject matter and predict the probability that a potential future event associated with that subject matter may occur.

In some embodiments, a multilayer perceptron (MLP) is a class of feedforward artificial neural networks. An MLP consists of, at least, three layers of nodes: an input layer, a hidden layer, and an output layer. Except for the input nodes, each node is a neuron that uses a nonlinear activation function. MLP utilizes a supervised learning technique called backpropagation for training. Its multiple layers and non-linear activation distinguish MLP from a linear perceptron. It can distinguish data that is not linearly separable. Also, MLP can be applied to perform regression operations.

However, accurate event prediction for is not possible with traditional neural networks since terms are not listed in ground truth repositories. For example, if a manufacturer of a device has not been previously identified, the neural network may not be able to identify such a manufacturer.

The amount of data that may be necessary for accurate prediction analysis may be sufficiently large for many subject matters that analyzing the data in a reasonable amount of time may be challenging. Further, in many subject matters, large amounts of data may be made available frequently (e.g., daily), and thus data may lose relevance quickly.

In some embodiments, multiple target predictions may be determined by the overall neural network and combined with structured data in order to predict the likelihood of a value at a range of confidence levels. In some embodiments, these neural networks may be any type of neural network. For example, “neural network” may refer to a classifier-type neural network, which may predict the outcome of a variable that has two or more classes (e.g., pass/fail, positive/negative/neutral, or complementary probabilities (e.g., 60% pass, 40% fail)). For example, pass may denote “no maintenance/service needed” and fail may denote “maintenance/service needed.” “Neural network” may also refer to a regression-type neural network, which may have a single output in the form, for example, of a numericalvalue.

In some embodiments, for example, a neural network in accordance with the present disclosure may be configured to generate a prediction of the probability of a detected network device. This configuration may comprise organizing the component neural networks to feed into one another and training the component neural networks to process data related to the subject matter. In embodiments in which the output of one neural network may be used as the input to a second neural network, the transfer of data from the output of one neural network to the input of another may occur automatically, without userintervention.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computerinstructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A system comprising:
a memory storing program instructions; and
a processor in communication with the memory, the processor being configured to execute the program instructions to perform processes comprising:
receiving information about auser;
tracking a gaze of the user on a user interface;
generating a real-time gaze heat map for the user;
feeding information about the user and the real-time gaze heat map into a machine learning model;
determining, using the machine learning model based on the information about the user and the real-time gaze heat map, conditional formatting rules for data displayed on the user interface; and
formatting, based on the conditional formatting rules, the data displayed on the userinterface.

2. The system of claim 1, wherein the information about the user is selected from the group consisting of historical engagement data of the user, a role of the user, role-based access control of the user, access level of the user, interests and need of the user, key performance indicator for the role of the user, and geo-location based data for user.

3. The system of claim 1, wherein the memory stores further program instructions, and wherein the processor is configured to execute the further program instructions to perform the processes further comprising:
generating a post format gaze heat map to track a cascading gaze;
feeding the post format gaze heat map into the machine learning model;
determining, using the machine learning model based the post format gaze heat map, a new conditional formatting rule for the data displayed on the user interface; and
updating a formatting of the data based on the conditional formattingrule.

4. The system of claim 1, wherein the memory stores further program instructions, and wherein the processor is configured to execute the further program instructions to perform the processes further comprising:
receiving historical data on viewer interactions with the user interface;
and training the machine learning model based on this historical data.

5. The system of claim 4, wherein the memory stores the further program instructions, and wherein the processor is configured to execute the further program instructions to perform the processes further comprising:
refining the machine learning model using cross-validation and performancemetrics.

6. The system of claim 1, wherein the memory stores further program instructions, and wherein the processor is configured to execute the further program instructions to perform the processes further comprising:
the machine learning model is derived from a foundational model.

7. The system of claim1,
wherein the real-time gaze heat map is a time dependent heat map, and
wherein the machine learning model identifies patterns in the real-time gaze heat map and correlates the patterns with historical data to determine user intent and engagement.

8. A method comprising:
a memory storing program instructions; and
a processor in communication with the memory, the processor being configured to execute the program instructions to perform processes comprising:
receiving information about auser;
tracking a gaze of the user on a user interface;
generating a real-time gaze heat map for the user;
feeding information about the user and the real-time gaze heat map into a machine learning model;
determining, using the machine learning model based on the information about the user and the real-time gaze heat map, conditional formatting rules for data displayed on the user interface; and
formatting, based on the conditional formatting rules, the data displayed on the userinterface.

9. The method of claim 8, furthercomprising:
wherein the information about the user is selected from the group consisting of historical engagement data of the user, a role of the user, role-based access control of the user, access level of the user, interests and need of the user, key performance indicator for the role of the user, and geo-location based data for user.

10. The method of claim 8, furthercomprising:
generating a post format gaze heat map to track a cascading gaze;
feeding the post format gaze heat map into the machine learning model;
determining, using the machine learning model based the post format gaze heat map, a new conditional formatting rule for the data displayed on the user interface; and
updating a formatting of the data based on the conditional formattingrule.

11. The method of claim 8, furthercomprising:
receiving historical data on viewer interactions with the user interface; and
training the machine learning model based on this historical data.

12. The method of claim 11,comprising:
refining the machine learning model using cross-validation and performancemetrics.

13. The method of claim 8, furthercomprising:
the machine learning model is derived from a foundational model.

14. The method of claim8,
wherein the real-time gaze heat map is a time dependent heat map, and
wherein the machine learning model identifies patterns in the real-time gaze heat map and correlates the patterns with historical data to determine user intent and engagement.

15. A computer program product comprising a computer readable storage medium having program instructions embodied therewith, the program instructions executable by a processor to cause the processor to perform a method, the method comprising:
a memory storing program instructions; and
a processor in communication with the memory, the processor being configured to execute the program instructions to perform processes comprising:
receiving information about auser;
tracking a gaze of the user on a user interface;
generating a real-time gaze heat map for the user;
feeding information about the user and the real-time gaze heat map into a machine learning model;
determining, using the machine learning model based on the information about the user and the real-time gaze heat map, conditional formatting rules for data displayed on the user interface; and
formatting, based on the conditional formatting rules, the data displayed on the userinterface.

16. The computer program product of claim 15,
wherein the information about the user is selected from the group consisting of historical engagement data of the user, a role of the user, role-based access control of the user, access level of the user, interests and need of the user, key performance indicator for the role of the user, and geo-location based data for user.

17. The computer program product of claim 15, further comprising additional program instructions stored on the computer readable storage medium and configured to cause the processor to perform the method further comprising:
generating a post format gaze heat map to track a cascading gaze;
feeding the post format gaze heat map into the machine learning model;
determining, using the machine learning model based the post format gaze heat map, a new conditional formatting rule for the data displayed on the user interface; and
updating a formatting of the data based on the conditional formattingrule.

18. The computer program product of claim 15, further comprising additional program instructions stored on the computer readable storage medium and configured to cause the processor to perform the method further comprising:
receiving historical data on viewer interactions with the user interface; and
training the machine learning model based on this historical data.

19. The computer program product of claim 18, wherein the memory stores the further program instructions, and wherein the processor is configured to execute the further program instructions to perform the processes further comprising:
refining the machine learning model using cross-validation and performancemetrics.

20. The computer program product of claim 15, further comprising additional program instructions stored on the computer readable storage medium and configured to cause the processor to perform the method further comprising:
the machine learning model is derived from a foundational model.

21. A systemcomprising:
a memory storing program instructions; and
a processor in communication with the memory, the processor being configured to execute the program instructions to perform processes comprising:
receiving historical formatting preferences of a user;
tracking an eye focus point of the user on a user interface;
generating a real-time gaze heat map for the user;
feeding the historical formatting preferences and the real-time gaze heat map into a machine learning model;
determining, using the machine learning model based on the historical formatting preferences and the real-time gaze heat map, conditional formatting rules for data displayed on the user interface; and
formatting, based on the conditional formatting rules, the data displayed on the userinterface.

22. The system of claim 21, wherein the memory stores further program instructions, and wherein the processor is configured to execute the further program instructions to perform the processes further comprising:
generating a post format gaze heat map to track a cascading gaze;
feeding the post format gaze heat map into the machine learning model;
determining, using the machine learning model based the post format gaze heat map, a new conditional formatting rule for the data displayed on the user interface; and
updating a formatting of the data based on the conditional formattingrule.

23. The system of claim 21, wherein the memory stores further program instructions, and wherein the processor is configured to execute the further program instructions to perform the processes further comprising:
receiving historical data on viewer interactions with the user interface; and
training the machine learning model based on this historical data.

24. A methodcomprising:
receiving historical formatting preferences of a user;
tracking an eye focus point of the user on a user interface;
generating a real-time gaze heat map for the user;
feeding the historical formatting preferences and the real-time gaze heat map into a machine learning model;
determining, using the machine learning model based on the historical formatting preferences and the real-time gaze heat map, conditional formatting rules for data displayed on the user interface; and
formatting, based on the conditional formatting rules, the data displayed on the userinterface.

25. The method of claim 24, wherein the memory stores further program instructions, and wherein the processor is configured to execute the further program instructions to perform the processes further comprising:
generating a post format gaze heat map to track a cascading gaze;
feeding the post format gaze heat map into the machine learning model;
determining, using the machine learning model based the post format gaze heat map, a new conditional formatting rule for the data displayed on the user interface; and
updating a formatting of the data based on the conditional formattingrule.
